(19) United States
(12) Patent Application Publication
(10) Pub. No.: US 2002/0183037 A1
(43) Pub. Date: Dec. 5, 2002

(54) Panic relief system for mobile communication devices

(76) Inventors: Sinatra Frank Griffin, JR., Park Forest, IL (US); Patricia Nichole Griffin, Park Forest, IL (US)

Correspondence Address: Patricia Griffin, 9 Mantua Court, Park Forest, IL, 60466, US

(21) Appl. No.: 10/150,322

(22) Filed: May 16, 2002

Related U.S. Application Data
(60) Provisional application No. 60/294,935, filed on May 31, 2001.

(51) Int. Cl. H04M 11/00

(52) U.S. Cl. 455/404; 455/550

(57) ABSTRACT

The Panic Relief System for Mobile Communication Devices improves the contact tool by evolving the mechanism into a public safety message center and telephone. It allows the user (carrier) to deter perpetrators and call for help with one push of a button. Several options satisfy the user's individual needs thereby making the Panic Relief System personable and user-friendly. Furthermore, with the incorporation of an alarm system amid mobile communication devices, the anticipation is that public safety will increase and crime victimization will decrease.

### BACKGROUND OF THE INVENTION

The Panic Relief System for Mobile Communication Devices involves the field of consumer products & retail covering the areas of mobile communications, public safety and computer/tracking technology. It is a collaborative approach to the various areas; providing the reduction of victimization, specifically, crimes of violence or crimes which can lead to violence.

### BRIEF SUMMARY OF THE INVENTION

According to the U.S. Department of Justice, out of 28,779,800 crimes committed in 1999: 7,357,060 were personal crimes of violence (383,170 reported rape/sexual assaults, 810,220 reported robberies and 6,163,670 assaults). The Panic Relief System for Mobile Communication Devices will give the user the option of attracting attention to themselves in an attempt to deter perpetrators. It will also give the user the ability to contact preferred individuals (up to 8) and allow the 911-Calling Center to not only track their phone number and location—but their registered information (such as first and last name) and enable the Center to hear (and possibly record) the surrounding situation.

Because the U.S. Federal Communications Commission ruled that all cell-phone providers equip their phone with GPS receivers (based on the NENA projected total of emergency calls dialed from a wireless phone), the Panic Relief System comes at a good time. It works to enhance existing technology of the operating system within mobile communication devices and complies with the goals of public safety as administered by the government.

### BRIEF DESCRIPTION OF THE SEVERAL VIEWS OF THE DRAWING

FIG. 1 The Front of a Mobile Communication Device

shows where the panic relief button might appear on a typical cell phone. The ⊙ represents the Panic Relief Button, identified by a red circle in the center of a flexible (yet durable) rubber material (which is the same color as the device's casing). The actual location of the Panic Relief Button may be determined by the provider of the device in accordance with its particular model.

### DETAILED DESCRIPTION OF THE INVENTION

Forty six thousand Americans subscribe to wireless service every day, according to the Cellular Telephone Industry Association, and out of the estimated 150 million calls made to 911 last year, 45 million (calls) were made on cell phones. The National Emergency Number Association projects an increase of up to 100 million by the year 2005.

The Panic Relief System for Mobile Communication Devices works with existing technology to enhance public safety, and (with anticipation) decrease the amount of victimization. This is how the system works:

1) The mobile communication device will give the user (carrier) the option of programming up to 8 emergency numbers that—once saved by the user—will be stored in the ROM of the operating system.

2) Instructions will be programmed into the Microprocessor that allow the Panic Relief System to supercede other codes permitting the Relief System to activate even if the power of the mobile communication device is pushed off.

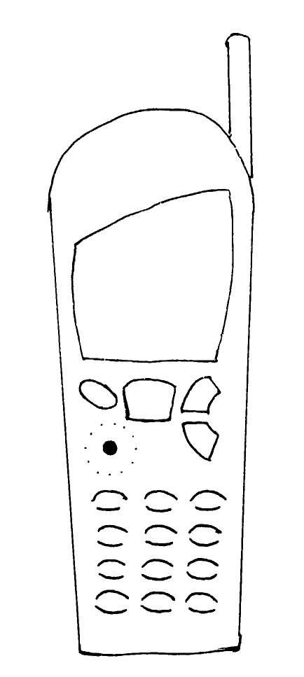

3) A Panic Relief Button is added to the keyboard of the mobile communication device (as shown in FIG. 1). This button would not protrude above the base of the keyboard allowing for a deliberate activation. The actual button resembles a rubber dome found in most computer keyboards and is produced in the same color as the device casing. This procedure will not only detract from its existence but also reduces the act of ‘accidental’ activation that can easily happen if the Panic Relief Button is the same (make, height) as the rest of the buttons on the keyboard. For design and practical purposes, the Panic Relief Button will have one red circle at the center of the ‘dome’. The instructions carried out by pressing the Panic Relief Button will be activated in the same manner as the rest of the keyboard on the mobile communication device.

4) Once the Panic Relief System is activated an alarm will sound (at a specified decibel—estimated at 120 dB).

5) Simultaneously, the microprocessor will self-dial the (up to) 8 pre-set numbers programmed by the user (carrier). It will contact one number at a time, starting with the first telephone number. After the initial contact is made, the operating system will be programmed to begin the initial contact of the second number—if a response (from the first emergency number) is not made after 3 rings. Sequentially, the third emergency number will be contacted if there is no response from the second phone number—after 3 rings, and so forth. This process will continue until a response is found. This means that even if the operating system gets through the entire contact list (pre-set emergency numbers), the system will implement the process again (starting with the first emergency number) until it receives a response.

Once a response is found, the user can communicate (talk) to the other person on the line. The Panic Relief System (alarm) is deactivated by simply pressing the Panic Relief Button (a second time after initial activation).

There will be an option for the user (carrier) to have the alarm muted for situations where ‘noise’ is not warranted, such as car-jacks, kidnapping and undercover assignments (occupations). It is in these circumstances that the Panic Relief System will work with the GPS and 911-Calling Center/PSAP.

1) Once the Panic Relief Button is activated, the operating system will be programmed to self-dial the 911-Calling Center—after which a programmed message will identify the user (carrier) based on the mobile communication device's SID (System Identification Code) and its location and phone number (as provided by the GPS/new tracking technology and ALI already being administered. The microprocessor will then instruct the execution of the mobile communication device to act as a ‘speaker phone’, allowing the Public-Safety Answering Point (PSAP) to hear the activities surrounding the location of the mobile communication device. With anticipation, the PSAP can record the findings.

Moreover, this will be beneficial during situations when the user (carrier) becomes panicked and is unable to speak, or speaking is not warranted.

1. What we claim as our invention is the development of an integration system, combining a crisis button, security alarm, continual self-dialing and speaker phone capabilities within mobile communication devices.

2. What we claim as our invention is the creation of a Panic Relief button, or similar thereof, enabling mobile communication devices to initiate automate contact, communication and activate a decibel or silent alarm as designated by the user.

3. What we claim as our invention is the development of a silent alarm, sending contact and communication to governing facilities, allowing these designated entities to hear and record critical situations.
